(19) United States
(12) Patent Application Publication
(10) Pub. No.: US 2023/0280318 A1
(43) Pub. Date: Sep. 7, 2023

(54) LEARNING DATA PRODUCING METHOD, WAVEFORM ANALYSIS DEVICE, WAVEFORM ANALYSIS METHOD, AND RECORDING MEDIUM

(71) Applicant: SHIMADZU CORPORATION, Kyoto (JP)

(72) Inventors: Shinji KANAZAWA, Kyoto (JP); Kenta CHINOMI, Kyoto (JP); Yuki SAKAMOTO, Kyoto (JP)

(21) Appl. No.: 18/113,689

(22) Filed: Feb. 24, 2023

(30) Foreign Application Priority Data
Mar. 3, 2022 (JP) 2022-032633

(51) Int. Cl. G01N 30/86

(52) U.S. Cl. CPC G01N 30/8634; G01N 30/8693; G01N 2030/025

(57) ABSTRACT

An analysis device produces learning data for training processing of an estimation model More specifically, the analysis device obtains a plurality of reference waveforms for a given type of device. In addition, the analysis device specifies information about a peak for each of the plurality of reference waveforms according to a criterion corresponding to the given type of device. The analysis device assigns the specified information about the peak to each of the plurality of reference waveforms.

### BACKGROUND OF THE INVENTION

### Field of the Invention

The present disclosure relates to a learning data producing method, a waveform analysis device, a waveform analysis method, and a recording medium for analyzing waveforms of a chromatogram and a spectrum.

### Description of the Background Art

Conventionally, a chromatograph has been used to identify or quantify components contained in a sample. In the chromatograph, components in the sample are separated by a column, and components flowing out from the column are sequentially detected. Thereafter, a chromatogram in which a horizontal axis represents time while a vertical axis represents detection intensity is produced.

In order to determine a peak height and area from the chromatogram, a peak start point rising from a baseline of the chromatogram and a peak end point are required to be identified. An operation of identifying the peak start and end points of the chromatogram is called peak picking. The peak height and area are determined by identifying the peak start and end points. A concentration of a compound corresponding to the peak and the like can be calculated from the peak height and area.

In recent years, an attempt to automate the peak picking using machine learning have been made. Among the machine learning methods, a technique using a technology of object detection and a technique using a technology of semantic segmentation are known as peak picking techniques using deep learning, as described in the following references.

### WO 2020/225864 (Patent Literature 1)

“AI-developed algorithms to help analyze data”, [online], [Searched on Sep. 6, 2021], Shimadzu Corporation, Internet <URL: https.//www.shimadzu.co.jp/news/press/jmsxjkglv6g0snf.html> (Non Patent Literature 1)

Kanazawa S, and 10 others, “Fake metabolomics chromatogram generation for facilitating deep learning of peak-picking neural networks”, J Biosci Bioeng. 2021 Feb.; 131 (2): 207 -212. doi: 10.1016/j.jbiosc., Sep. 13, 2020, Epub

### (Non Patent Literature 2)

Olaf Ronneberger and two others, “U-Net: Convolutional Networks for Biomedical Image Segmentation”, [online], (submitted on May 18, 2015) arXiv.org, Internet <URL: https://arxiv.org/pdf/1505.04597.pdt> (Non Patent Literature 3)

In particular, WO 2020/225864 discloses a method for displaying a certainty factor of a peak picking result using a single shot multibox detector (SSD) by formulating a peak picking problem as object detection in an image recognition field. The SSD collectively outputs the peak picking result and the certainty factor for the peak picking result. Non-Patent Literature 2 discloses a method for implementing the peak picking by formulating the peak picking problem as a semantic segmentation problem. Non-Patent Literature 3 discloses a peak picking technique using a neural network.

### SUMMARY OF THE INVENTION

In the peak picking using the machine learning as described above, improvement of accuracy is always required.

An object of the present disclosure is to provide a technique for improving the accuracy of the peak picking using the machine learning.

A method for producing learning data according to an aspect of the present disclosure is a computer-implemented method for producing learning data to produce an estimation model that causes a computer to function to output information about a peak in a target waveform based on a plurality of reference waveforms of a given type of device. The method includes: obtaining the plurality of reference waveforms; specifying the information about the peak according to a criterion corresponding to the given type of device for each of the plurality of reference waveforms; and assigning the specified information about the peak to each of the plurality of reference waveforms.

A waveform analysis device according to another aspect of the present disclosure includes: an interface that obtains a target waveform of a given type of device; and one or more processors that input the target waveform to a trained estimation model and acquire information about a peak in the target waveform. The estimation model is subjected to training processing using learning data produced by assigning the information about the peak specified according to a criterion corresponding to the given type of device to each of a plurality of reference waveforms of the given type of device so as to output the information about the peak in the target waveform when the target waveform is input.

A computer-implemented method for waveform analysis according to still another aspect of the present disclosure includes: obtaining a target waveform of a given type of device; and inputting the target waveform to a trained estimation model and acquiring information about a peak in the target waveform. The estimation model is subjected to training processing using learning data produced by assigning the information about the peak specified according to a criterion corresponding to the given type of device to each of a plurality of reference waveforms of the given type of device so as to output the information about the peak in the target waveform when the target waveform is input.

A recording medium according to yet another aspect of the present disclosure non-temporarily records a computer program that is executed by at least one processor of a computer to cause the computer to perform the computer-implemented method for waveform analysis.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an entire configuration of an analysis device 1.

FIG. 2 is a view illustrating an example of a chromatogram.

FIG. 3 is a view illustrating another example of the chromatogram.

FIG. 4 is a block diagram illustrating a procedure for producing a trained model.

FIG. 5 is a view illustrating still another example of the chromatogram.

FIG. 6 is a view schematically illustrating a candidate of a peak region selected by a user with respect to a chromatogram 400 in FIG. 5.

FIG. 7 is a view schematically illustrating a specific example of a data configuration of learning data.

FIG. 8 is a flowchart illustrating a procedure for producing the learning data.

FIG. 9 is a flowchart illustrating a procedure for producing the trained model.

FIG. 10 is a flowchart illustrating a procedure for determining chromatogram data using the trained model (trained estimation model 300).

FIG. 11 is a view illustrating an example of a determination result of the trained model.

FIG. 12 is a view illustrating an example of a graph on which labeling processing is performed based on the determination result.

FIG. 13 is a view illustrating an example of an image 120 displaying the determination result.

### DESCRIPTION OF THE PREFERRED EMBODIMENT

With reference to the drawings, embodiments of the present disclosure will be described in detail below. In the drawings, the same or corresponding portion is denoted by the same reference numeral, and the description thereof will not be repeated.

### Configuration of Analysis Device

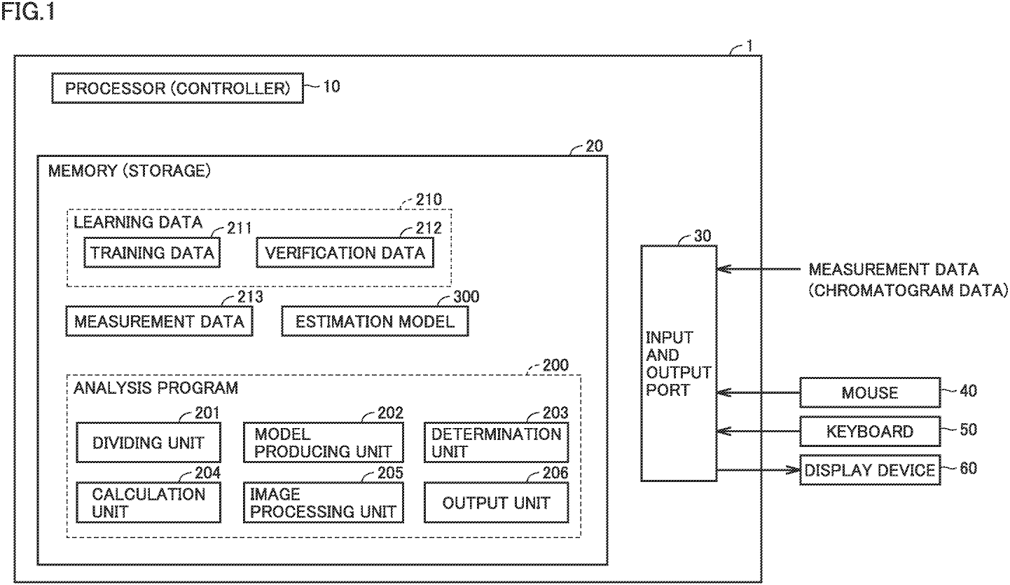

FIG. 1 is a block diagram illustrating an entire configuration of an analysis device 1. Analysis device 1 includes a processor 10 that functions as a controller, a memory 20 that functions as a storage, and an input and output port 30. A mouse 40, a keyboard 50, and a display device 60 are connected to input and output port 30. A mass spectrometer or the like may be connected to input and output port 30. One or a plurality of terminal devices may be connected to input and output port 30 through the Internet, an internal network, or the like.

For example, analysis device 1 is configured using a personal computer as a base. Analysis device 1 may be configured by a server that can be accessed from one or a plurality of terminal devices through a network such as the Internet.

Measurement data (chromatogram data) is input to input and output port 30. The measurement data may be used as an analysis target or used to produce learning data of an estimation model. The measurement data may be input to analysis device 1 through a mass spectrometer connected to input and output port 30. The gas chromatograph mass spectrometry system may be configured by a mass spectrometer, a gas chromatograph connected to the mass spectrometer, and analysis device 1.

Memory 20 stores at least learning data 210, measurement data 213, an estimation model 300 used for machine learning, and an analysis program 200 executing analysis processing and machine learning processing. Measurement data 213 may be input to input and output port 30. Analysis program 200 may be non-temporarily recorded in memory 20. Memory 20 may be a recording medium detachable from analysis device 1.

Learning data 210 includes a plurality of learning samples. The plurality of learning samples are classified into training data 211 and verification data 212. In one implementation example, 80% of the plurality of learning samples is classified as training data 211, and 20% is classified as verification data 212. That is, in this example, when 14250 learning samples (30 sets of sample sets each including 475 chromatograms) are prepared, 11400 learning samples are classified into training data 211, and 2850 learning samples are classified into verification data 212. However, a ratio between the training data 211 and the verification data 212 is not limited thereto, but can be appropriately set.

Training data 211 and verification data 212 include waveform data of the chromatogram obtained by measuring a sample containing various components using a chromatograph mass spectrometer. For example, the chromatogram is a total ion chromatogram representing a temporal change in total intensity of ions of all detected mass-to-charge ratios obtained by MS scanning measurement of components separated by a gas chromatograph using a mass spectrometer. The chromatogram may be a mass chromatogram that is measured by SIM measurement or MRM measurement to represent a temporal change in intensity of ions of a specific mass-to-charge ratio.

Training data 211 and verification data 212 include information about a peak as correct answer data. The information about the peak is specified by the peak picking. The peak picking is performed on the chromatogram included in each of training data 211 and verification data 212. The information about the peak may include information about a position of the peak (the position of the peak start point, the position of the peak top and/or the position of the peak end point).

The waveform data (chromatogram) included in each of training data 211 and verification data 212 is previously normalized so as to be within a predetermined range (for example, ±1.0) of the intensity value. The accuracy of the trained model can be enhanced by unifying a plurality of chromatograms having different intensity scales by the normalization to a common intensity scale.

The chromatogram included in each of training data 211 and verification data 212 may be a chromatogram obtained by measuring an actual sample or be a chromatogram produced by simulation (for example, see Non-Patent Literature 2).

The waveform of the chromatogram is divided into a predetermined number of partial waveforms in a time-axis direction. For example, the predetermined number is 512 or 1024, and is set such that a width (a length in the time-axis direction) of each partial waveform is at least smaller than a peak width. For example, the predetermined number is determined based on magnitude of the peak width and the number of data points required for forming one peak.

Each partial waveform data is associated with information (characteristic information) about the peak of the partial waveform. Characteristic information associated with the partial waveform includes at least information indicating whether the partial waveform belongs to a peak region or a non-peak region.

A dividing unit 201, a model producing unit 202, a determination unit 203, a calculation unit 204, an image processing unit 205, and an output unit 206 are configured by analysis program 200.

Dividing unit 201 divides the waveform of the chromatogram into a predetermined number of partial waveforms. Using learning data 210, model producing unit 202 advances the machine learning of estimation model 300 to produce trained estimation model 300.

Determination unit 203 performs the peak picking of the chromatogram using trained estimation model 300. Hereinafter, sometimes trained estimation model 300 is referred to as a “trained model”.

Calculation unit 204 calculates the certainty factor of the determination result of determination unit 203. Image processing unit 205 produces image data including the determination result and the certainty factor. Output unit 206 outputs a display signal including the image data from input and output port 30 to display device 60. Analysis device 1 may include display device 60.

### Example of Chromatogram

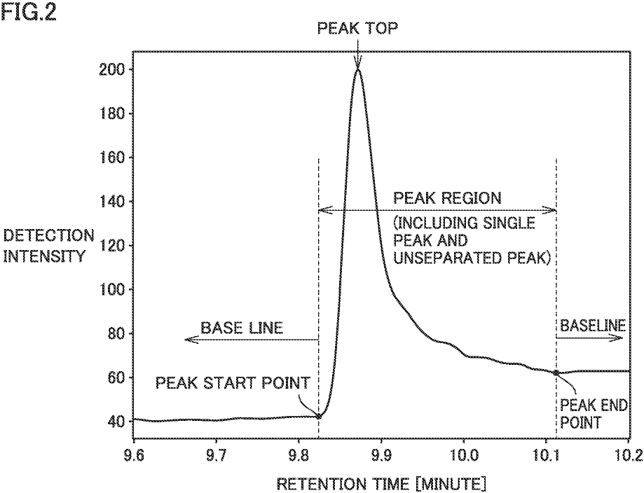

FIG. 2 is a view illustrating an example of the chromatogram. Here, the name of each portion specified from the chromatogram will be briefly described. The chromatogram can be classified into a portion of the baseline and the peak region. A rising portion from the baseline is referred to as the peak start point and the peak end point. The region between the peak start point and the peak end point is referred to as the peak region. In the peak region, a portion where detection intensity is very strong (the strongest portion) is referred to as a peak top.

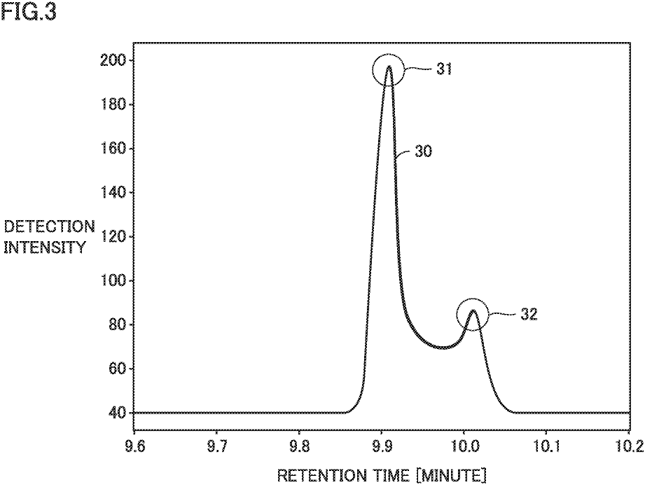

In one implementation example, the peak region is divided into a single peak and an unseparated peak. FIG. 2 illustrates the single peak. FIG. 3 is a view illustrating another example of the chromatogram. In a waveform 30 of FIG. 3, as illustrated as regions 31, 32, two mountain-shaped waveforms having the peak top as the top are connected. The detection intensity of the portion corresponding to a valley between these two mountain-shaped waveforms does not drop to the intensity corresponding to the baseline. The mountain-shaped waveform including region 31 and the mountain-shaped waveform including region 32 are both referred to as the unseparated peak.

### Production of Trained Model

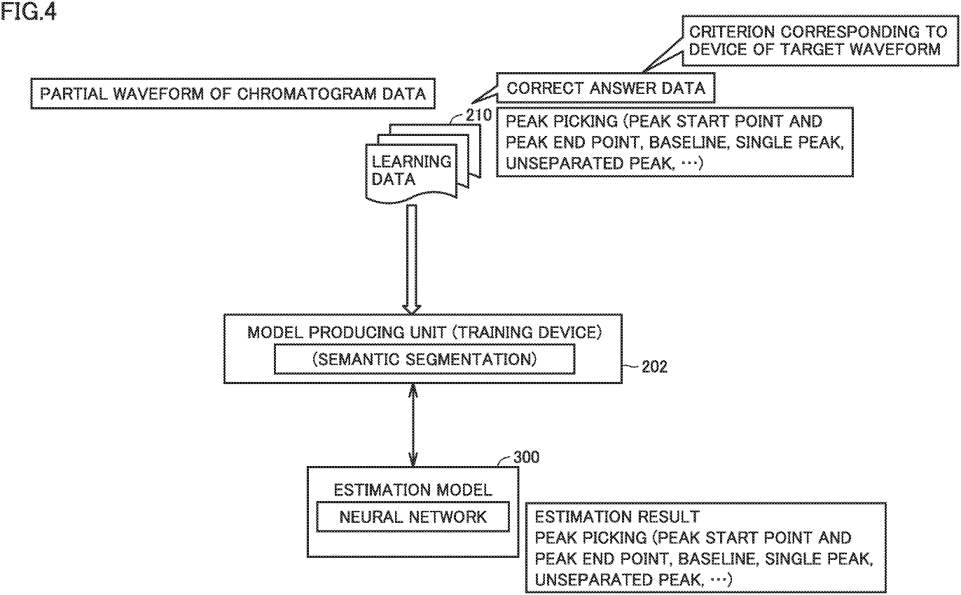

A procedure for producing the trained model will be described below. FIG. 4 is a block diagram illustrating the procedure for producing the trained model.

As illustrated in FIG. 4, model producing unit 202 of analysis device 1 functions as a training device. Model producing unit 202 causes estimation model 300 to learn based on learning data 210. Estimation model 300 performs deep learning using a neural network. Estimation model 300 includes parameters such as weighting coefficients used for calculation by the neural network.

For example, a supervised learning algorithm is used to cause estimation model 300 to learn. Model producing unit 202 causes estimation model 300 to learn by the supervised learning using learning data 210.

A technique of semantic segmentation is used to learn estimation model 300. The semantic segmentation is generally used to analyze an image configured by two-dimensionally-distributed pixel data. In the embodiment, the semantic segmentation is applied to the analysis of the waveform of the chromatogram configured of data arranged one-dimensionally along a time axis. For example, U-Net, SeGNet, or PSPNet can be used as an estimation model capable of executing the semantic segmentation. In the embodiment, U-Net is used.

As illustrated in FIG. 4, learning data 210 includes chromatogram data and correct answer data. More specifically, learning data 210 is a set of learning samples, and each learning sample includes the chromatogram data and the correct answer data. Still more specifically, in the embodiment, each learning sample includes the correct data produced for each partial waveform of the chromatogram data.

The partial waveform of the chromatogram and correct answer data corresponding to the partial waveform of the chromatogram are input to model producing unit 202. For example, the correct answer data is a peak picking result that is already specified. The peak picking result may include the peak top.

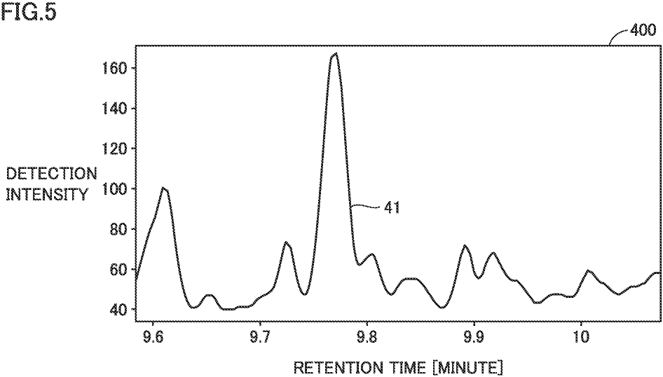

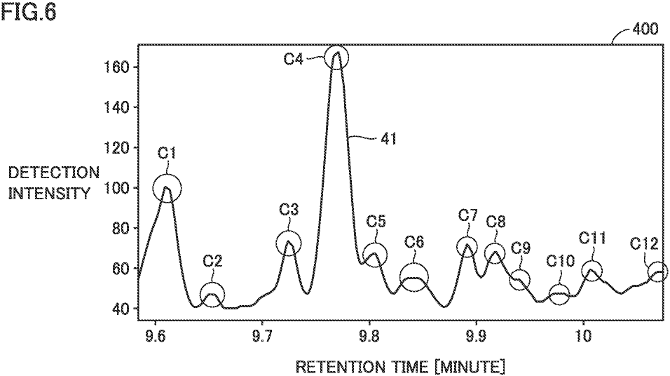

In the embodiment, the correct answer data is produced according to a criterion corresponding to the type of the device of the chromatogram to be analyzed by estimation model 300. With reference to FIGS. 5 and 6, the production of the correct answer data will be described later.

Model producing unit 202 derives the peak picking result for the chromatogram by applying the chromatogram in learning data 210 to estimation model 300, and causes estimation model 300 to learn based on the derived result and the correct answer data. Specifically, model producing unit 202 causes estimation model 300 to learn by adjusting the parameter in estimation model 300 such that the result derived by estimation model 300 approaches the correct answer data.

### Production of Correct Answer Data

With reference to FIGS. 5 and 6, the production of the correct answer data will be described. FIG. 5 is a view illustrating still another example of the chromatogram. In a chromatogram 400 of FIG. 5, a vertical axis represents the detection intensity, a horizontal axis represents a retention time, and a waveform 41 represents a change in the detection intensity with respect to the retention time. FIG. 6 is a view schematically illustrating a candidate of the peak region selected by a user with respect to chromatogram 400 in FIG. 5. In FIG. 6, regions C1 to C12 are added. Each of regions C1 to C12 indicates at least a part of each of the 12 peak region candidates selected by the user for waveform 41 in the embodiment. In the present specification, the “peak region” may be simply referred to as a “peak”, and the “peak region candidate” may be simply referred to as a “peak candidate”.

In the embodiment, as described above, the correct answer data is produced according to the criterion corresponding to the type of the device of the chromatogram to be analyzed by estimation model 300.

For example, when the type of the device of the chromatogram to be analyzed in the estimation model 300 is a gas chromatograph, the correct answer data is produced according to the criterion corresponding to the gas chromatograph. That is, when estimation model 300 is used for estimating the information about the peak with respect to the chromatogram obtained as the analysis result by the gas chromatograph, the correct answer data added to each of a plurality of chromatograms included in learning data 210 (training data 211 and verification data 212) is produced according to the criterion corresponding to the gas chromatograph.

Setting a threshold of an S/N ratio specifying as a peak in the peak picking to a smaller value is an example of the criterion corresponding to the gas chromatograph. More specifically, the threshold of the S/N ratio to be specified as the peak is set to the smaller value with respect to the small peak before and after the main peak. The S/N ratio is the intensity of the peak top relative to the intensity of noise set for the gas chromatogram.

In one implementation example, when the analysis target is the chromatogram of the general chromatograph (for example, a liquid chromatograph), the S/N ratio specifying as the peak is “at least 10”, but when the analysis target is the chromatogram of the gas chromatograph, the S/N ratio specifying as the peak may be “at least 5”. Furthermore, for the peak adjacent to the main peak having the S/N ratio of “at least 10” and having a separation degree less than or equal to a certain value, the S/N ratio may be set to “at least a value smaller than 10 (for example, at least 5)”. In the gas chromatograph, a sample to be measured is derivatized. Thus, in the chromatogram of the gas chromatograph, small peaks are often generated before and after the main peak. By adjusting the threshold of the S/N ratio as described above, the small peaks before and after the main peak, which are assumed to be generated in the chromatogram of the gas chromatograph, can be more reliably specified as the peak in the peak picking. When the peak candidate is specified as the peak, information about the candidate peak is produced as the correct answer data. When the peak candidate is not specified as the peak, information about the candidate peak is not included in the correct answer data.

The chromatogram of the gas chromatograph may be a chromatogram measured by the gas chromatograph, or be a chromatogram produced by simulation as the measurement result of the gas chromatograph.

For example, the “small peak before and after the main peak” is defined as a peak that is adjacent to another peak and has a given value of the separation degree between the small peak and the another peak specified in the peak picking. At this point, the “another peak” is the “main peak”. It is assumed that the “main peak” has the S/N ratio specified as the peak in the peak picking with respect to the general chromatogram. The separation degree is an index indicating how much a certain peak is separated from another adjacent peak (“Story of separation degree No. 1”, Shimadzu Corporation, searched on Jan. 12, 2022, [online], <URL: https://www.an.shimadzu.co.jp/hplc/support/lib/lctalk/81/81intro.htm>). In one example, when the value calculated as the separation degree from the main peak adjacent to a certain peak is less than or equal to 1.5, the peak is specified as the “small peak before and after the main peak”. However, the value (1.5) of the separation degree used here is merely an example, and can be appropriately changed according to a situation to which the technique according to the present disclosure is applied.

The “small peaks before and after the main peak” will be described more specifically. For example, in the example of FIG. 6, it is assumed that the peak in region C4 is selected as the “main peak” because the S/N ratio is greater than or equal to 10, but the peak in region C5 is not selected as the “main peak” because the S/N ratio is less than 10. In this case, the separation degree between the peak in region C4 and the peak in region C5 is calculated. When the separation degree is less than 1.5, the peak in region C5 is specified as the peak in the peak picking when the S/N ratio is greater than or equal to 5.

Another example of the criterion corresponding to the gas chromatograph is to specify the small peak as the peak in the peak picking when the detection intensity of the small peak before and after the main peak is greater than or equal to a given ratio with respect to the detection intensity of the main peak. For example, the given ratio is ⅒.

In one implementation example, when the analysis target is the chromatogram of the general chromatograph, it is assumed that the S/N ratio specifying as the peak is greater than or equal to 10. On the other hand, when the analysis target is the chromatogram of the gas chromatograph, the S/N ratio is adjacent to the main peak greater than or equal to 10 even when the S/N ratio is the peak less than 10, and when the peak top having the detection intensity greater than or equal to ⅒ of the detection intensity of the peak top of the main peak is included, the S/N ratio is specified as the peak in the peak picking. When the peak is specified based on the criterion related to the detection intensity of the peak top of the main peak in this manner, the small peak before and after the main peak, which is assumed to be generated in the chromatogram of the gas chromatograph, can be more reliably specified as the peak in the peak picking.

In still another example of the criterion corresponding to the gas chromatograph, when the noise cannot be checked in the chromatogram, the condition of the S/N ratio to be specified as the peak is not provided.

In one implementation example, when the analysis target is the chromatogram of the general chromatograph, it is assumed that the S/N ratio specifying as the peak is greater than or equal to 10. On the other hand, when the analysis target is the chromatogram of the gas chromatograph, and when the noise is not visible in the chromatogram, all peaks in regions C1 to C12 selected as the candidate by the user are specified as the peak in the peak picking regardless of the S/N ratio. As described above, when the noise is not visible, the candidate of the peak is specified as the peak regardless of the S/N ratio of the peak top, whereby the candidate to be specified as the peak can be reliably specified as the peak even when the noise is not visible due to generation of a large number of peaks in the chromatogram. Such the criterion corresponds to the fact that the range of the retention time of the chromatogram obtained by the measurement by the gas chromatograph is generally shorter than that of the chromatogram obtained by the measurement by the liquid chromatograph. Shortening of the range of the retention time of the chromatogram obtained by the measurement by the gas chromatograph is caused from the fact that deviation of the retention time in the measurement by the gas chromatograph is smaller than that in the measurement by the liquid chromatograph.

An example of the case where the noise is visible is a state in which a change remains within a certain range (for example, within the detection intensity greater than or equal to 5 for 0.1 minutes) for at least a certain time, such as the detection intensity in a range of the retention time of 9.6 minutes to 9.8 minutes in FIG. 2. That is, when a duration during which the detection intensity is located within a certain range is greater than or equal to a certain time, it is determined that the noise is visible in the chromatogram. On the other hand, as illustrated in FIG. 6, an example of the case where the noise is not visible is a state in which there is no portion where the change in the detection intensity falls within the certain range for at least the certain time. That is, when the duration in which the detection intensity is located within the certain range is less than the certain time, it is determined that no noise is visible in the chromatogram.

A plurality of conditions specifying the peak candidate as the peak are described above. These conditions may be applied alone, or applied in combination of a plurality of conditions.

### Specific Example of Correct Answer Data

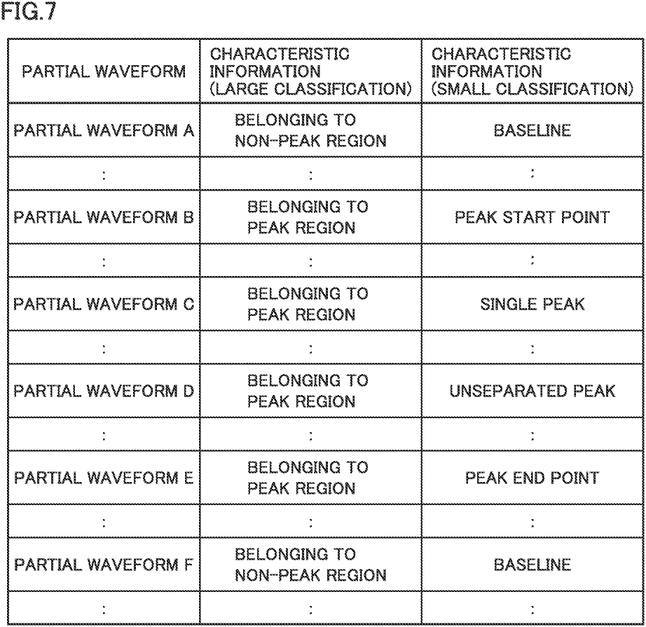

FIG. 7 is a view schematically illustrating a specific example of a data configuration of the learning data. FIG. 7 illustrates an example of the data configuration of the learning sample. The example in FIG. 7 illustrates the data configuration of one learning sample. In the example of FIG. 7, the waveform included in one chromatogram is divided into a plurality of partial waveforms, and characteristic information (correct answer data) is added to each partial waveform. The data configuration in FIG. 7 is merely an example, and in the learning data of the embodiment, the waveform of one chromatogram does not need to be divided into partial waveforms.

As illustrated in FIG. 7, characteristic information about a large classification and characteristic information about a small classification are added to each partial waveform as the correct answer data. The large-classification characteristic information indicates whether the partial waveform belongs to the peak region or the non-peak region. The small-classification characteristic information indicates an attribute that the partial waveform has in the peak region or the non-peak region. For example, in a partial waveform A, “belonging to the non-peak region” is added as the large-classification characteristic information, and “baseline” is added as the small-classification characteristic information.

The type of information included in the correct answer data is not limited to the type of information indicated as the characteristic information of the large and small classifications as illustrated in FIG. 7. The correct answer data may include other types of information such as the detection intensity of the peak top.

### Processing Flow (Production of Learning Data)

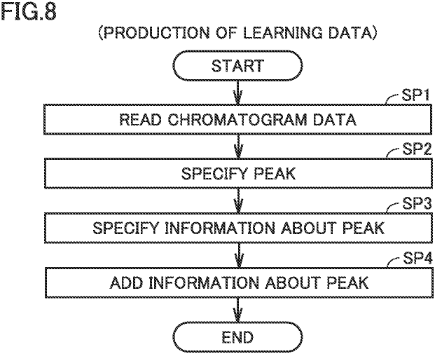

FIG. 8 is a flowchart illustrating a procedure for producing the learning data. According to the flowchart, one learning sample constituting the learning data is produced. In one implementation example, analysis device 1 executes the processing of this flowchart by causing processor 10 to execute analysis program 200 for the learning data.

In step SP1, analysis device 1 reads chromatogram data. In one implementation example, the chromatogram data is input through input and output port 30 or produced by simulation and stored in memory 20. Processor 10 reads the chromatograph data from memory 20. The chromatogram data read in step SP1 is data used for the training processing of estimation model 300, and is an example of the reference waveform.

In step SP2, analysis device 1 specifies the peak for the waveform included in the chromatogram data. In one implementation example, the user selects the peak candidate for the waveform, specifies the peak from the peak candidates according to the criterion, and inputs the specified peak to analysis device 1. Analysis device 1 specifies the peak with respect to the waveform included in the chromatograph data according to the input from the user. Analysis device 1 may specify the peak from the chromatogram data according to the criterion without requiring input from the user.

In step SP3, analysis device 1 specifies information about the peak. In one implementation example, the user specifies the information about the peak (for example, the characteristic information in FIG. 7) and inputs the information to analysis device 1. Analysis device 1 specifies the information about the peak according to input from the user.

In step SP4, analysis device 1 adds the information about the peak to the chromatogram data. One learning sample is produced by adding the information about the peak to the chromatogram data read in step SP1. The produced learning sample is stored in memory 20 as training data 211 or verification data 212.

Thereafter, analysis device 1 ends the processing of the flowchart in FIG. 8. Analysis device 1 produces the learning data by performing the processing in FIG. 8 for each learning sample.

### Flow of Processing (Production of Trained Model)

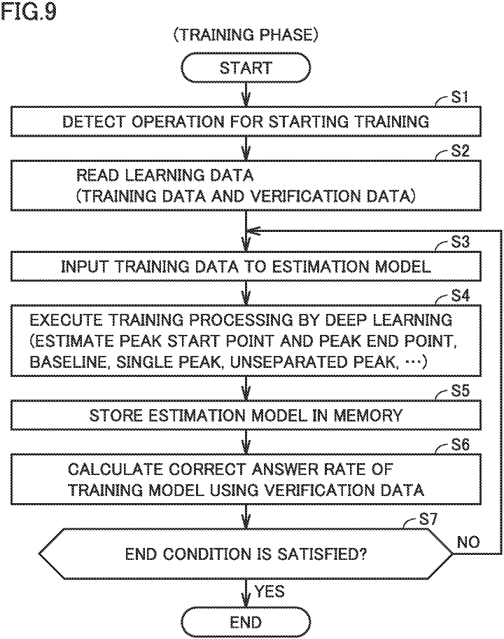

FIG. 9 is a flowchart illustrating a procedure for producing the trained model. Analysis device 1 executes the processing of this flowchart by causing processor 10 to execute analysis program 200.

First, processor 10 detects an operation for starting training of estimation model 300 (step S1). For example, when the user performs the operation for starting the training of estimation model 300 using mouse 40 and keyboard 50, the operation is detected in step S1.

Subsequently, processor 10 reads learning data 210 (training data 211 and verification data 212) from memory 20 (step S2). Subsequently, processor 10 inputs training data 211 to estimation model 300 (step S3). Subsequently, in estimation model 300, the training processing by the deep learning is executed (step S4). In the U-Net used for the training of estimation model 300 in the embodiment, the weighting of the neural network is adjusted such that correct characteristic information can be obtained from the partial waveform.

More specifically, the parameter of the estimation model 300 is adjusted based on the partial waveform of training data 211 and the characteristic information associated with the partial waveform. In the processing for adjusting the parameter, processing for estimating the single peak, the unseparated peak, the peak start point, the peak end point, the baseline, and the like and processing for comparing the estimation result with correct answer data are executed.

Subsequently, processor 10 stores estimation model 300 produced according to the result of the training processing of step S4 in memory 20 (step S5).

Subsequently, processor 10 calculates a correct answer rate of the characteristic information added by analyzing the partial waveform of verification data 212 by estimation model 300 (step S6).

Subsequently, processor 10 determines whether a predetermined end condition is satisfied (step S7). For example, when the number of times of the training processing repeatedly performed using training data 211 reaches a predetermined number, processor 10 determines that the end condition is satisfied. When the end condition is not satisfied, processor 10 repeats the control of steps S3 to S6 until the end condition is satisfied.

When the termination condition is satisfied, processor 10 terminates the series of processing in FIG. 9.

### Analysis of Waveform of Chromatogram

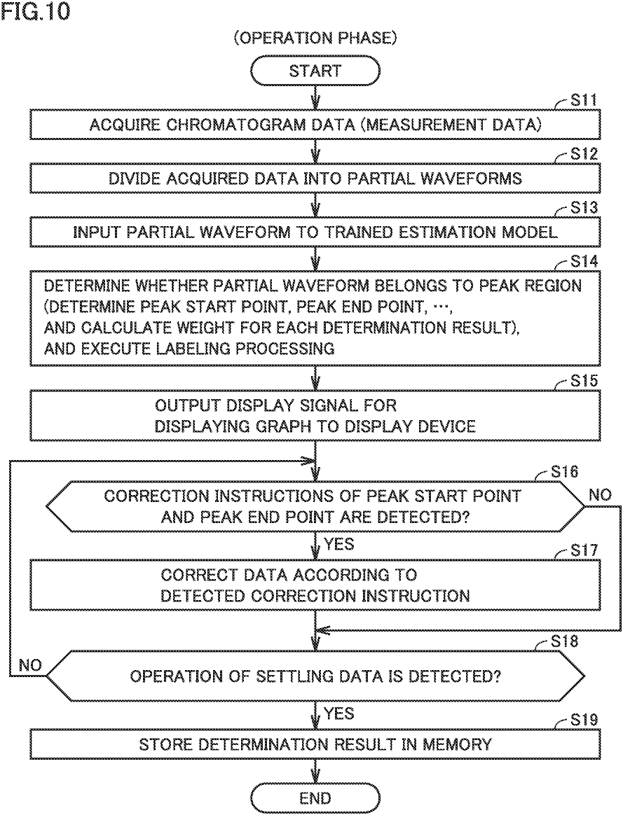

With reference to a flowchart, a procedure for analyzing the waveform of an unanalyzed chromatogram will be described below. FIG. 10 is a flowchart illustrating a procedure for determining the chromatogram data using the trained model (trained estimation model 300). Processor 10 of analysis device 1 executes a part of analysis program 200, thereby implementing the processing of this flowchart.

First, processor 10 obtains the chromatogram data (measurement data) (step S11). The chromatogram data is input to analysis device 1 through a measuring instrument such as a mass spectrometer connected to input and output port 30 of a terminal device connected to input and output port 30. The data obtained in step S11 is data to be estimated of the information about the peak, and is an example of the target waveform.

Subsequently, processor 10 divides the waveform of the obtained chromatogram into a predetermined number of partial waveforms (step S12). The number of divisions of the chromatogram waveform may be the same as or different from the number of divisions of training data 211 and verification data 212.

However, the number of divisions is determined according to the length of the waveform (the length of the execution time of the chromatograph mass spectrometry) such that the width (the length in the time-axis direction) of each partial waveform is at least smaller than the width of the peak predicted to be included in the chromatogram. For example, it is conceivable to set the number of divisions to 512 or 1024.

Subsequently, processor 10 inputs the partial waveform to trained estimation model 300 (trained model) (step S13). Subsequently, processor 10 determines whether or the partial waveform belongs to the peak region as the trained model, and executes labeling processing (step S14). More specifically, the peak start point and the peak end point, the baseline, the single peak, the unseparated peak, the peak top, and the like are determined from the partial waveform. In addition, the weight of each determination result is calculated. In addition, in step S14, the characteristic information (information about whether the partial waveform belongs to the peak region) is added to each partial waveform.

Subsequently, processor 10 produces a graph indicating the determination result and outputs a display signal for displaying the produced graph to display device 60 (step S15). As a result, the determination result is displayed on display device 60. For example, in a screen of display device 60, the peak start point and the peak end point are displayed on the waveform of the chromatogram.

Subsequently, processor 10 determines whether correction instructions of the peak start point and the peak end point are detected (step S16). In the embodiment, the user can perform the operation for correcting the peak start point and the peak end point on the screen of display device 60. Processor 10 advances the control to step S17 when the correction instructions are detected, and advances the control to step S18 when the correction instruction is not detected.

When the user performs the operation for correcting the peak start point and the peak end point using mouse 40 and keyboard 50, processor 10 corrects the data on the screen according to the correction instructions (step S17). In this manner, processor 10 receives the correction instructions of the user and corrects the peak start point and the peak end point.

After correcting the data, processor 10 determines whether an operation of settling the data is detected (step S18). When the operation settling the data is not detected, processor 10 returns the control to step S16. When the operation settling the data is detected, processor 10 stores the determination result (the corrected determination result when the data is corrected) in memory 20 (step S19), and ends the processing based on this flowchart.

### Example of Determination Result

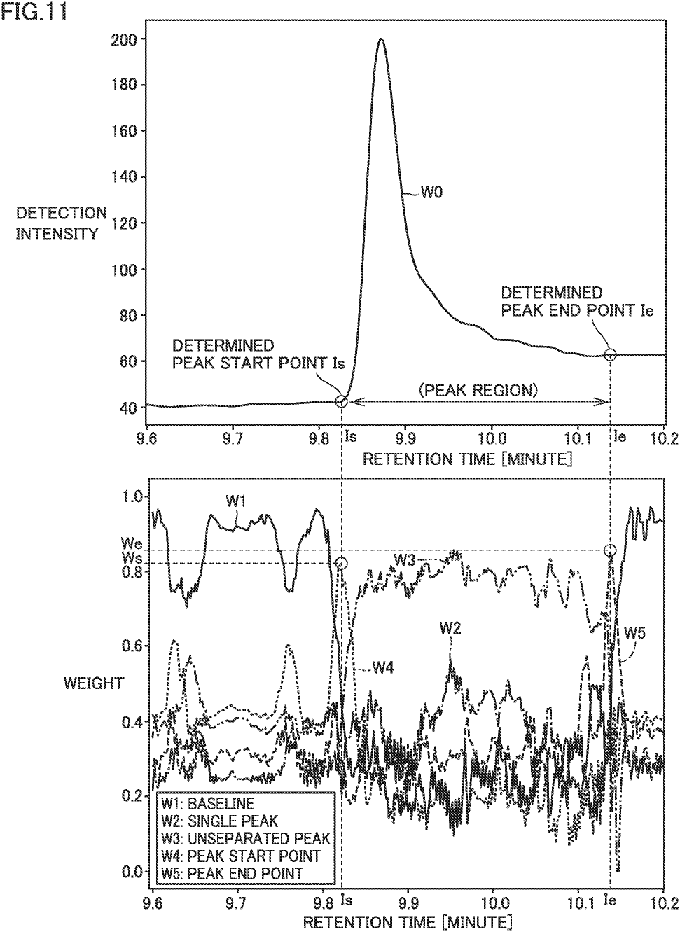

FIG. 11 is a view illustrating an example of the determination result of the trained model. An upper graph in FIG. 11 illustrates a waveform W0 of the input chromatogram. A lower graph in FIG. 11 represents the determination result of the trained model for the input chromatogram. The horizontal axis (index) of both graphs corresponds to the time axis. The vertical axis of the upper graph in FIG. 11 represents the detection intensity. The vertical axis of the lower graph in FIG. 11 indicates the weight output by the trained model. The weight is normalized to a range of 0 to 1.

Waveforms W1 to W5 indicated as the determination results of the trained model correspond to the baseline, the single peak, the unseparated peak, the peak start point, and the peak end point, respectively. By comparing waveform W0 of the chromatogram with waveforms W1 to W5, for example, it can be seen that the weight corresponding to the peak start point becomes the highest at the position of an index Is in waveform W0 of the chromatogram. Similarly, it can be seen that the weight corresponding to the peak end point becomes the highest at the position of an index Ie in waveform W0 of the chromatogram. In this case, for example, analysis device 1 determines the position of index Is in waveform W0 of the chromatogram as the peak start point, and determines the position of index Ie as the peak end point.

Here, examples of the determination target include the peak start point, the peak end point, the single peak, the unseparated peak, and the baseline, but another element such as the peak top can be added to the determination target.

As illustrated in FIG. 11, processor 10 specifies the certainty factor of the peak by calculating an average value of a weight Ws corresponding to a peak start point Is determined by the trained model and a weight We corresponding to a peak end point Ie determined by the trained model.

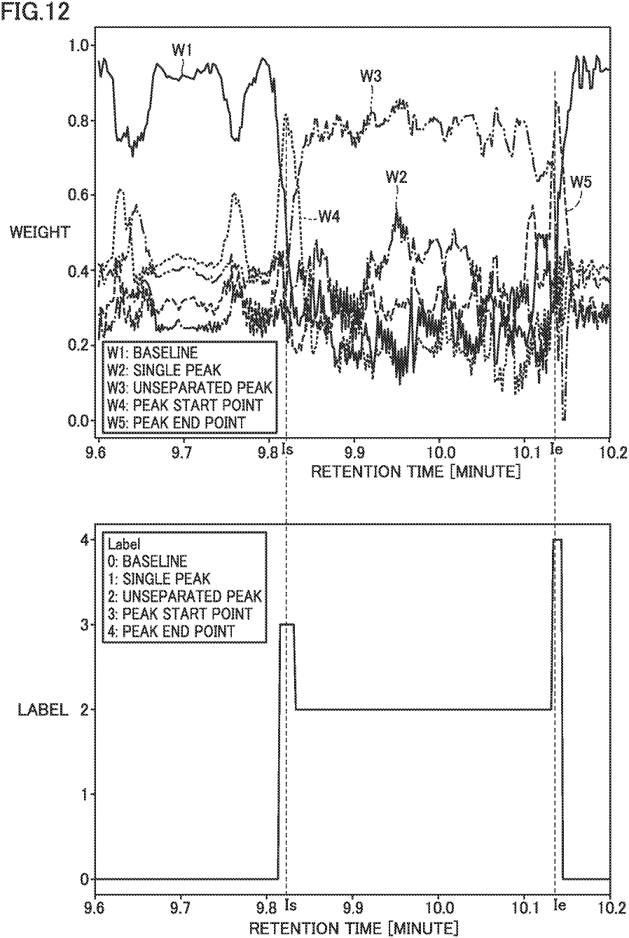

FIG. 12 is a view illustrating an example of a graph on which the labeling processing is performed based on the determination result. The upper graph in FIG. 12 is the same as the lower graph in FIG. 11. The lower graph in FIG. 12 is a graph in which waveform W0 (see FIG. 11) of the input chromatogram is labeled based on waveforms W1 to W5. Labels 0 to 4 correspond to the baseline, the single peak, the unseparated peak, the peak start point, and the peak end point, respectively.

For example, the labeling processing is performed in the following procedure. That is, among waveforms W1 to W5, the waveform having the largest weight at the position of a certain index Ix is selected, and the value of index Ix is labeled by the selected waveform. The labeling processing ends by repeating the same processing while changing x from the initial value to the final value of the index. For example, FIG. 12 illustrates a graph in which an interval from indexes 0 to Is labeled (label = 0) as the baseline.

### Display of Determination Result

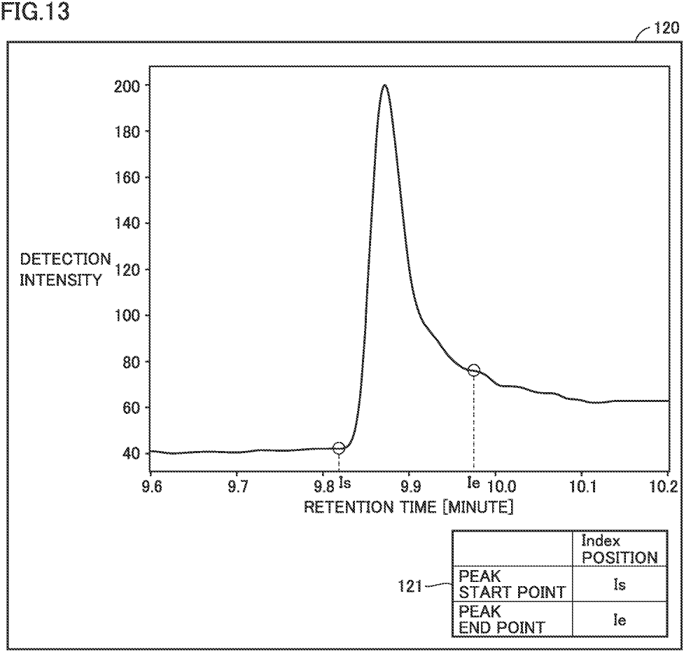

FIG. 13 is a view illustrating an example of image 120 displaying the determination result. Image 120 is displayed by display device 60. Image 120 includes a field 121 including peak start point Is and peak end point Ie corresponding to the determination result together with the waveform of the chromatogram to be analyzed. The determination result is information about the peak acquired for waveform 121. Processor 10 may include the determination result other than peak start point Is and peak end point Ie in field 121, and include the certainty factor calculated as described above in image 120.

In addition to image 120, processor 10 can selectively display the image including two graphs of an aspect in FIG. 11, the image including two graphs of an aspect in FIG. 12, and the image in which three graphs included in FIGS. 11 and 12 are arranged in the vertical direction on display device 60. The certainty factor calculated as described above may be displayed together in any image. In addition, the correct answer rate of the model calculated in step S6 (FIG. 9) may be displayed in any image. The user can input an instruction indicating which image is to be displayed to analysis device 1 using mouse 40 and keyboard 50.

Processor 10 may include information indicating the above-described criterion producing the learning data for the trained model used to derive the determination result in image 120.

The embodiment is merely an example, and can be appropriately changed according to the gist of the present disclosure. Here, the case of processing the waveform of the chromatogram obtained by chromatograph mass spectrometry is described as an example. However, a chromatograph including a detector (spectrophotometer) other than the mass spectrometer and a chromatogram acquired by the gas chromatograph can also be similarly analyzed by analysis device 1. Furthermore, the analysis target is not limited to the chromatogram. For example, a spectroscopic spectrum (the waveform representing the change in detection intensity with respect to the wavelength or a wavenumber axis) acquired by measurement using the spectrophotometer may be analyzed. Any waveform obtained by LC, GC, LC-PDA, LC/MS, GC/MS, LC/MS/MS, GC/MS/MS, LC/MS-IT-TOF, or the like may be analyzed.

### Aspects

It is understood by those skilled in the art that the above-described embodiments and modification thereof are specific examples of the following aspects.

(Item 1) A method for producing learning data according to an aspect is a computer-implemented method for producing learning data to produce an estimation model that causes a computer to function to output information about a peak in a target waveform based on a plurality of reference waveforms of a given type of device. The method may include: obtaining the plurality of reference waveforms; specifying the information about the peak according to a criterion corresponding to the given type of device for each of the plurality of reference waveforms; and assigning the specified information about the peak to each of the plurality of reference waveforms.

According to the method for producing learning data described in item 1, there is provided a technique for improving accuracy of peak picking using machine learning in the peak picking for a target waveform of the given device.

(Item 2) In the method for producing learning data described in item 1, the given type of device may include a gas chromatograph.

According to the method for producing learning data described in item 2, there is provided a technique for improving accuracy of peak picking using machine learning in the peak picking for a target waveform of the given device including the gas chromatograph.

(Item 3) In the method for producing learning data described in item 1 or 2, the criterion may include, in order to specify a peak candidate as a peak in each reference waveform, a first item that an S/N ratio of the peak candidate is greater than or equal to a first value and a second item that the peak candidate is adjacent to a peak specified according to the first item and the S/N ratio of the peak candidate is greater than or equal to a second value smaller than the first value.

According to the method for producing learning data described in item 3, small peaks before and after the main peak can be more reliably specified as the peak in the peak picking.

(Item 4) In the method for producing learning data described in item 3, the second item may include a separation degree from the peak specified according to the first item, the separation degree being less than or equal to a predetermined value.

According to the method for producing learning data described in item 4, small peaks before and after the main peak can be more reliably specified as the peak in the peak picking.

(Item 5) In the method for producing learning data described in item 3, the second item may include detection intensity of the peak candidate that is greater than or equal to a given ratio with respect to detection intensity of the peak specified according to the first item in order to specify the peak candidate as the peak.

According to the method for producing learning data described in item 5, small peaks before and after the main peak can be more reliably specified as the peak in the peak picking.

(Item 6) In the method for producing learning data described in any one of items 1 to 5, the criterion may include specifying a peak candidate as the peak in each reference waveform regardless of an S/N ratio of the peak candidate when duration of a signal in a given intensity range is less than a given time in each reference waveform.

According to the method for producing learning data described in item 6, even when noise cannot be seen due to generation of a large number of peaks in the chromatogram, a candidate to be specified as the peak can be reliably specified as the peak.

(Item 7) A waveform analysis device according to an aspect may include: an interface that obtains a target waveform of a given type of device; and one or more processors that input the target waveform to a trained estimation model and acquire information about a peak in the target waveform. The estimation model may be subjected to training processing using learning data produced by assigning the information about the peak specified according to a criterion corresponding to the given type of device to each of a plurality of reference waveforms of the given type of device so as to output the information about the peak in the target waveform when the target waveform is input.

According to the waveform analysis device described in item 7, the estimation model learned to improve the accuracy of the peak picking using machine learning is used in the peak picking for the target waveform of the given device.

(Item 8) In the waveform analysis device described in item 7, the given type of device may include a gas chromatograph.

According to the waveform analysis device described in item 8, the estimation model learned to improve the accuracy of the peak picking using the machine learning is used in the peak picking for the target waveform of the given device including the gas chromatograph.

(Item 9) In the waveform analysis device described in item 7 or 8, the criterion may include, in order to specify a peak candidate as a peak in each reference waveform, a first item that an S/N ratio of the peak candidate is greater than or equal to a first value and a second item that the peak candidate is adjacent to a peak specified according to the first item and the S/N ratio of the peak candidate is greater than or equal to a second value smaller than the first value.

According to the waveform analysis device described in item 9, the estimation model learned using the learning data that enables the small peak before and after the main peak to be more reliably specified as the peak in the peak picking is used for the peak picking.

(Item 10) In the waveform analysis device described in item 9, the second item may include a separation degree from the peak specified according to the first item, the separation degree being less than or equal to a predetermined value.

According to the waveform analysis device described in item 10, small peaks before and after the main peak can be more reliably specified as the peak in the peak picking.

(Item 11) In the waveform analysis device described in item 9, the second item may include a detection intensity of the peak candidate that is greater than or equal to a given ratio with respect to detection intensity of the peak specified according to the first item in order to specify the peak candidate as the peak.

According to the waveform analysis device described in item 11, the estimation model learned using the learning data that enables the small peak before and after the main peak to be more reliably specified as the peak in the peak picking is used for the peak picking.

(Item 12) In the waveform analysis device described in any one of items 7 to 11, the criterion may include specifying a peak candidate as the peak in each reference waveform regardless of an S/N ratio of the peak candidate when duration of a signal in a given intensity range is less than a given time in each reference waveform.

According to the waveform analysis device described in item 12, even when noise cannot be seen due to generation of a large number of peaks in the chromatogram, the estimation model learned using the learning data with which a candidate to be specified as the peak can be reliably specified as the peak is used for the peak picking.

(Item 13) A computer-implemented method for waveform analysis according to one aspect may include: obtaining a target waveform of a given type of device; and inputting the target waveform to a trained estimation model and acquiring information about a peak in the target waveform. The estimation model may be subjected to training processing using learning data produced by assigning the information about the peak specified according to a criterion corresponding to the given type of device to each of a plurality of reference waveforms of the given type of device so as to output the information about the peak in the target waveform when the target waveform is input.

According to the method described in item 13, the estimation model learned to improve accuracy of peak picking using machine learning is used in peak picking for a target waveform of a given device.

(Item 14) In the method described in item 13, the given type of device may include a gas chromatograph.

According to the method described in item 14, the estimation model learned to improve the accuracy of the peak picking using the machine learning is used in the peak picking for the target waveform of the given device including the gas chromatograph.

(Item 15) In the method described in item 13 or 14, the criterion may include, in order to specify a peak candidate as a peak in each reference waveform, a first item that an S/N ratio of the peak candidate is greater than or equal to a first value and a second item that the peak candidate is adjacent to a peak specified according to the first item and the S/N ratio of the peak candidate is greater than or equal to a second value smaller than the first value.

According to the method described in item 15, the estimation model learned using the learning data that enables the small peak before and after the main peak to be more reliably specified as the peak in the peak picking is used for the peak picking.

(Item 16) In the method described in item 15, the second item may include a separation degree from the peak specified according to the first item, the separation degree being less than or equal to a predetermined value.

According to the method described in item 16, small peaks before and after the main peak can be more reliably specified as the peak in the peak picking.

(Item 17) In the method described in item 15, the second item may include a detection intensity of the peak candidate that is greater than or equal to a given ratio with respect to detection intensity of the peak specified according to the first item in order to specify the peak candidate as the peak.

According to the method described in item 17, the estimation model learned using the learning data that enables the small peak before and after the main peak to be more reliably specified as the peak in the peak picking is used for the peak picking.

(Item 18) In the method described in any one of items 13 to 17, the criterion may include specifying a peak candidate as the peak in each reference waveform regardless of an S/N ratio of the peak candidate when duration of a signal in a given intensity range is less than a given time in each reference waveform.

According to the method described in item 18, even when noise cannot be seen due to generation of a large number of peaks in the chromatogram, the estimation model learned using the learning data with which a candidate to be specified as the peak can be reliably specified as the peak is used for the peak picking.

(Items 19) A computer program according to an aspect is executed by at least one processor of a computer to cause the computer to perform the method described in any one of items 13 to 18.

According to the computer program described in item 19, the estimation model learned to improve the accuracy of the peak picking using the machine learning is used in the peak picking for the target waveform of the given device.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A computer-implemented method for producing learning data to produce an estimation model that causes a computer to function to output information about a peak in a target waveform based on a plurality of reference waveforms of a given type of device, the method comprising:
obtaining the plurality of reference waveforms;
specifying the information about the peak according to a criterion corresponding to the given type of device for each of the plurality of reference waveforms; and
assigning the specified information about the peak to each of the plurality of reference waveforms.

2. The method for producing learning data according to claim 1, wherein the given type of device includes a gas chromatograph.

3. The method for producing learning data according to claim 1, wherein the criterion includes, in order to specify a peak candidate as a peak in each reference waveform, a first item that an S/N ratio of the peak candidate is greater than or equal to a first value and a second item that the peak candidate is adjacent to a peak specified according to the first item and the S/N ratio of the peak candidate is greater than or equal to a second value smaller than the first value.

4. The method for producing learning data according to claim 3, wherein the second item includes a separation degree from the peak specified according to the first item, the separation degree being less than or equal to a predetermined value.

5. The method for producing learning data according to claim 3, wherein the second item includes detection intensity of the peak candidate that is greater than or equal to a given ratio with respect to detection intensity of the peak specified according to the first item in order to specify the peak candidate as the peak.

6. The method for producing learning data according to claim 1, wherein the criterion includes specifying a peak candidate as the peak in each reference waveform regardless of an S/N ratio of the peak candidate when duration of a signal in a given intensity range is less than a given time in each reference waveform.

7. A waveform analysis device comprising:
an interface that obtains a target waveform of a given type of device; and
one or more processors that input the target waveform to a trained estimation model and acquire information about a peak in the target waveform,
wherein the estimation model is subjected to training processing using learning data produced by assigning the information about the peak specified according to a criterion corresponding to the given type of device to each of a plurality of reference waveforms of the given type of device so as to output the information about the peak in the target waveform when the target waveform is input.

8. The waveform analysis device according to claim 7, wherein the given type of device includes a gas chromatograph.

9. The waveform analysis device according to claim 7, wherein the criterion includes, in order to specify a peak candidate as a peak in each reference waveform, a first item that an S/N ratio of the peak candidate is greater than or equal to a first value and a second item that the peak candidate is adjacent to a peak specified according to the first item and the S/N ratio of the peak candidate is greater than or equal to a second value smaller than the first value.

10. The waveform analysis device according to claim 9, wherein the second item includes a separation degree from the peak specified according to the first item, the separation degree being less than or equal to a predetermined value.

11. The waveform analysis device according to claim 9, wherein the second item includes detection intensity of the peak candidate that is greater than or equal to a given ratio with respect to detection intensity of the peak specified according to the first item in order to specify the peak candidate as the peak.

12. The waveform analysis device according to claim 7, wherein the criterion includes specifying a peak candidate as the peak in each reference waveform regardless of an S/N ratio of the peak candidate when duration of a signal in a given intensity range is less than a given time in each reference waveform.

13. A computer-implemented method for waveform analysis comprising:
obtaining a target waveform of a given type of device; and
inputting the target waveform to a trained estimation model and acquiring information about a peak in the target waveform,
wherein the estimation model is subjected to training processing using learning data produced by assigning the information about the peak specified according to a criterion corresponding to the given type of device to each of a plurality of reference waveforms of the given type of device so as to output the information about the peak in the target waveform when the target waveform is input.

14. The method according to claim 13, wherein the given type of device includes a gas chromatograph.

15. The method according to claim 13, wherein the criterion includes, in order to specify a peak candidate as a peak in each reference waveform, a first item that an S/N ratio of the peak candidate is greater than or equal to a first value and a second item that the peak candidate is adjacent to a peak specified according to the first item and the S/N ratio of the peak candidate is greater than or equal to a second value smaller than the first value.

16. The method according to claim 15, wherein the second item includes a separation degree from the peak specified according to the first item, the separation degree being less than or equal to a predetermined value.

17. The method according to claim 15, wherein the second item includes detection intensity of the peak candidate that is greater than or equal to a given ratio with respect to detection intensity of the peak specified according to the first item in order to specify the peak candidate as the peak.

18. The method according to claim 13, wherein the criterion includes specifying a peak candidate as the peak in each reference waveform regardless of an S/N ratio of the peak candidate when duration of a signal in a given intensity range is less than a given time in each reference waveform.

19. A recording medium non-temporarily recording a computer program that is executed by at least one processor of a computer to cause the computer to perform the method according to claim 13.
